(19) United States
(12) Patent Application Publication
(10) Pub. No.: US 2010/0196765 A1
(43) Pub. Date: Aug. 5, 2010

(54) Reducing DC Resistance In Electrochemical Cells By Increasing Cathode Basis Weight

(75) Inventors: Marcus Palazzo, Wheatfield, NY (US); Esther Takeuchi, East Amherst, NY (US); Randolph Leising, Williamsville, NY (US)

Correspondence Address: Greatbatch Ltd., 10,000 Wehrle Drive, Clarence, NY, 14031, US

(73) Assignee: GREATBATCH, INC., Clarence, NY (US)

(21) Appl. No.: 11/163,644

(22) Filed: Oct. 26, 2005

Related U.S. Application Data
(60) Provisional application No. 60/622,339, filed on Oct. 26, 2004.

(51) Int. Cl. H01M 6/16; H01M 4/00; H01M 10/26; H01M 4/58; H01M 4/82; H01M 10/04

(52) U.S. Cl. 429/338; 429/220; 429/207; 429/231.95; 29/623.5

(57) ABSTRACT

The use of an increased cathode weight and thickness or basis weight in a primary electrochemical cell for the purpose of reducing DC resistance (Rdc) is described. This is particularly important when the cell is subjected to high rate discharge conditions of the type typically required for medical device applications, such as activating a cardiac defibrillator. A preferred couple is of a lithium/silver vanadium oxide (Li/SVO) cell or a lithium/copper silver vanadium oxide (Li/CSVO) cell. Reducing cell Rdc by increasing basis weight has the added benefit of increasing the cell's energy density through comparatively greater amounts of active cathode material in a give casing volume.

### BACKGROUND OF THE INVENTION

1. Field of Invention

The present invention relates to the conversion of chemical energy to electrical energy and, more particularly, to decreasing the DC resistance (Rdc) of an electrochemical cell by using a cathode weight range optimized to the required current density. This invention has been proven to result in relatively higher efficiency in solid cathode systems activated with nonaqueous electrolytes.

2. Prior Art

A relatively low Rdc is an important attribute for an electrochemical cell, especially one required to provide sufficiently high energy in a short period of time to power an implantable medical device, such as a cardiac defibrillator. DC resistance is an opposition force to the flow of current by ionic conductivity. Because of this, Rdc results in lower discharge voltages during high current drain. In the case of a cardiac defibrillator, a high Rdc means an increased time to charge capacitors in the medical device (increased charge time) and, in turn, a longer time to provide therapy to the patient. Consequently, it is important to reduce Rdc in electrochemical cells for high current drain applications of the type required by cardiac defibrillators, and the like.

Recognition of the problems attendant with increased Rdc has resulted in the battery industry adopting several curative methods to reduce Rdc in certain electrochemical chemistries. One is to diminish Rdc by incorporating a conductive diluent into the cathode to lower the overall electrical resistance of the composite electrode active mixture. A high surface area carbon material is a commonly used conductive additive. Another technique is to increase the ionic mobility or conductivity within a cathode. This is accomplished by using electrode materials having smaller particle sizes or thin electrodes. For example, it is well known that utilizing very thin electrodes in lithium ion electrochemical systems, particularly one having LiCoO₂ as a cathode material, results in a cell with relatively higher rate capability and lower Rdc. However, increased rate capability comes with a penalty of reduced energy density, since thinner electrodes necessarily use more current collector and separator materials, which are inactive components that decrease cell energy density.

### SUMMARY OF THE INVENTION

While conductive additives and thin electrode designs result in lower Rdc in certain electrochemical systems, the present method achieves the same result using an increased cathode weight and thickness in a mixed metal oxide solid cathode. In particular, the use of an increased cathode weight and thickness or basis weight in a primary electrochemical cell results in reduced Rdc under high rate discharge conditions of the type typically required for medical device applications, such as activating a cardiac defibrillator. A preferred system comprises lithium coupled with a metal vanadium oxide-containing material such as a lithium/silver vanadium oxide (Li/SVO) cell or a lithium/copper silver vanadium oxide (Li/CSVO) cell. Reducing cell Rdc by increasing basis weight has the added benefit of increasing the cell's energy density through comparatively greater amounts of active cathode material in a give casing volume.

Thus, the present invention is directed to the fabrication of cathodes for use in primary electrochemical cells exhibiting reduced DC resistance or Rdc, particularly under pulse discharge conditions. For that purpose, the cathode active material is present in the cathode at a basis weight of about 0.023 grams/cm² to about 0.075 grams/cm², more preferably about 0.035 grams/cm² to about 0.065 grams/cm², and most preferably at about 0.045 grams/cm² to about 0.055 grams/cm². This is a relatively higher basis weight than would be expected in many other types of electrochemical systems. For example, in a secondary cell, such as of a carbonaceous anode coupled with a lithium cobalt oxide (LiCoO₂) cathode, it is known that a relatively thinner or lower basis weight is desirable for reducing Rdc, particularly under heavy load conditions. Unexpectedly, it has been discovered that a primary lithium/solid cathode active material couple does not necessarily follow conventional expectations.

These and other objects of the present invention will become increasingly more apparent to those skilled in the art by reference to the following description and the appended drawings.

### BRIEF DESCRIPTION OF THE DRAWINGS

FIG. 1 is a graph comparing the pulsed Rdc discharge results of five Li/SVO coin cells having cathodes of various thicknesses containing a binder mixture of PVDF and polyamic acid plotted versus capacity.

FIG. 2 is a graph of the pulse-1 Rdc values versus basis weight for each of the coin cells used to construct the graph of FIG. 1.

FIG. 3 is a graph comparing the pulsed Rdc discharge results of two Li/SVO coin cells having cathodes of different thicknesses containing a binder of PTFE plotted versus capacity.

FIG. 4 is a graph of the pulse-1 Rdc values versus basis weight for a plurality of jellyroll configured cells having cathodes of various basis weights that were subjected to pulse discharge using various current densities to arrive at a normalized Rdc.

### DETAILED DESCRIPTION OF THE INVENTION

As used herein, the term “basis weight” is defined as the gram amount of active material per unit of surface area. The units are typically expressed as grams/cm² or grams/in².

The term “pulse” means a short burst of electrical current of significantly greater amplitude than that of a pre-pulse current or open circuit voltage immediately prior to the pulse. A pulse train consists of at least one pulse of electrical current. The pulse is designed to deliver energy, power or current. If the pulse train consists of more than one pulse, they are delivered in relatively short succession with or without open circuit rest between the pulses. An exemplary pulse train may consist of one to four 5 to 20-second pulses (23.2 mA/cm²) with about a 10 to 30 second rest, preferably about 15 second rest, between each pulse. A typically used range of current densities for cells powering implantable medical devices is about 15 mA/cm² to about 50 mA/cm², and more preferably about 18 mA/cm² to about 35 mA/cm². Typically, a 10 second pulse is suitable for medical implantable applications. However, it could be significantly shorter or longer depending on the specific cell design and chemistry and the associated device energy requirements. Current densities are based on square centimeters of the cathode electrode.

A primary electrochemical cell constructed according to the present invention includes an anode active material selected from Groups IA, IIA, or 111B of the Periodic Table of Elements, including lithium, sodium, potassium, etc., and their alloys and intermetallic compounds including, for example Li—Si, Li—B, Li—Mg, and Li—Si—B alloys and intermetallic compounds. The preferred anode active material comprises lithium and preferably a lithium alloy. The preferred lithium alloy is a lithium-aluminum alloy. The greater the amounts of aluminum present by weight in the alloy, however, the lower the energy density of the cell.

The form of the anode or negative electrode may vary. The anode is preferably a thin metal sheet or foil of the anode metal, pressed or rolled on a metallic anode current collector, i.e., preferably comprising nickel. The anode current collector has an extended tab or lead contacted by a weld to a cell case of conductive metal in a case-negative electrical configuration. Alternatively, the anode may be formed in some other geometry, such as a bobbin shape, cylinder or pellet to allow an alternate low surface cell design.

The cathode active material is preferably of a solid, lithium retentive material as the electrochemical reaction at the cathode involves conversion of ions that migrate from the anode to the cathode in atomic or molecular forms. The solid cathode material may comprise a metal, a metal oxide, a mixed metal oxide, a metal sulfide or a carbonaceous compound, and combinations thereof. The metal oxide, the mixed metal oxide and the metal sulfide can be formed by the chemical addition, reaction, or otherwise intimate contact of various metal oxides, metal sulfides and/or metal elements, preferably during thermal treatment, sol-gel formation, chemical vapor deposition or hydrothermal synthesis in mixed states. The active materials thereby produced contain metals, oxides and sulfides of Groups IB, IIB, IIIB, IVB, VB, VIIB, VIIB and VIII, which includes the noble metals and/or other oxide and sulfide compounds.

One preferred mixed metal oxide is a metal vanadium oxide having the general formula SMₓV₂O_{y} where SM is a metal selected from Groups IB to VIIB and VIII of the Periodic Table of Elements, x is about 0.30 to 2.0 and y is about 4.5 to 6.0 in the general formula. By way of illustration, and in no way intended to be limiting, one exemplary metal vanadium oxide comprises silver vanadium oxide having the general formula AgₓV₂O_{y} in any one of its many phases, i.e., β-phase silver vanadium oxide having in the general formula x=0.35 and y=5.8, γ-phase silver vanadium oxide having in the general formula x=0.74 and y=5.37 and ε-phase silver vanadium oxide having in the general formula x=1.0 and y=5.5, and combination and mixtures of phases thereof. For a more detailed description of such cathode active materials reference is made to the previously discussed U.S. Pat. No. 4,310,609 to Liang et al.

Another preferred metal vanadium oxide cathode material includes V₂O_{z} wherein z≦5 combined with Ag₂O with silver in either the silver(II), silver(I) or silver(0) oxidation state and CuO with copper in either the copper(II), copper(I) or copper(0) oxidation state to provide the mixed metal oxide having the general formula CuₓAg_{y}V₂O_{z}, (CSVO) with 0.01≦z≦6.5. Typical forms of CSVO are Cu_{0.16}Ag_{0.67}V₂O_{z} with z being about 5.5 and Cu_{0.5}Ag_{0.5}V₂O_{z} with z being about 5.75. The oxygen content is designated by z since the exact stoichiometric proportion of oxygen in CSVO can vary depending on whether the cathode material is prepared in an oxidizing atmosphere such as air or oxygen, or in an inert atmosphere such as argon, nitrogen and helium. For a more detailed description of this cathode active material reference is made to U.S. Pat. Nos. 5,472,810 to Takeuchi et al. and 5,516,340 to Takeuchi et al., both of which are assigned to the assignee of the present invention and incorporated herein by reference.

Other cathode active materials useful for fabrication of primary cells include manganese dioxide, copper vanadium oxide, titanium disulfide, copper oxide, copper sulfide, iron sulfide, iron disulfide, fluorinated carbon, and mixtures thereof.

A typical cathode or positive electrode for a nonaqueous, lithium electrochemical cell is made from a mixture of a cathode active material, a conductive diluent and a polymeric binder. Suitable conductive diluents include acetylene black, carbon black, graphite, carbon fiber, carbon nanotubes, and mixtures thereof. Metals such as nickel, aluminum, titanium and stainless steel in powder form are also useful as conductive diluents when mixed with the above listed active materials.

The polymeric binder is used in its broadest sense. Any material which is inert in the cell and which passes through a thermoplastic state, whether or not it finally sets or cures, is included within the term “polymeric binder”. Representative materials include polyethylene, polypropylene and fluoropolymers such as fluorinated ethylene propylene, polytetrafluoroethylene (PTFE), polyhexafluoropropylene, tetrafluoroethylene-hexafluoropropylene copolymers, tetrafluoroethylene-perfluoroalkyl vinyl ether copolymers, polytrifluoroethylene, ethylene-tetrafluoroethylene copolymers, fluoroethylene-hydrocarbon vinyl ether copolymers, polychlorotrifluoroethylene, ethylene-chlorotrifluoroethylene copolymers, polyvinyl fluoride, polyvinylidene fluoride (PVDF), vinylidene fluoride-hexafluoropropylene copolymers, fluorinated (meth)acrylate resins, 2-fluoroacrylate resins, fluorinated epoxy resins, fluorinated epoxy (meth)acrylate resins, fluorinated polyether resins, fluorinated polyimide resins, fluorinated polyester resins, fluorinated polyamide resins, fluorinated polycarbonate resins, fluorinated polyformal resins, fluorinated polyketone resins, fluorinated polyazomethine resins, fluorinated polyazole resins, and fluorinated polyallyloxysilane resins. Other suitable binders include fluorinated elastomers. A polyimide derived from a polyamic acid precursor is also a useful binder as are natural rubbers.

The active formulation comprises about 80 to 95 weight percent of the cathode active material, about 1 to 10 weight percent of the conductive diluent and about 1 to 10 weight percent of the polymeric binder. Less than 1 weight percent of the binder provides insufficient cohesiveness to the loosely agglomerated cathode active material particles to prevent delamination, sloughing and cracking during electrode preparation and cell fabrication and during cell discharge. More than 10 weight percent of the binder provides a cell with diminished capacity and reduced current density due to lowered electrode active density.

In that respect, preparation of a cathode preferably begins by dissolving or dispersing the binder in a solvent, although the binder material may sometimes be used without a solvent. Suitable solvents include water, methyl ethyl ketone, cyclohexanone, isophoron, N-methyl-2-pyrrolidone (NMP), N,N-dimethylformamide, N,N-dimethylacetamide, toluene, and mixtures thereof.

One preferred electrochemical couple is of a lithium/silver vanadium oxide chemistry. Another is of a lithium/copper silver vanadium oxide chemistry. In either case, the cathode is formed by adding PVDF to a polyamic acid/solvent slurry. This slurry is stirred to create a low viscosity mixture. Separately, dry SVO or CSVO is milled with conductive additives to create a homogeneous mixture that is then mixed with the diluted binder slurry causing uniform coating of the SVO or CSVO with the binder materials. Upon drying, the coated active material is press contacted to a cathode current collector to provide greater SVO or CSVO particle-to-particle contact. Pressing the cathode structure before curing also ensures that the active mixture is in close contact with the current collector substrate prior to conversion of the polyamic acid to the polyimide.

The polyamic acid-containing cathode structure is then heat cured to crosslink the packed SVO or CSVO together and in close contact with the current collector substrate. Cured is preferably performed at a temperature of about 225° C. to about 275° C. for a period of about 30 minutes to about 2 hours. A more preferred curing protocol is to heat the electrode at about 260° C. for about 1 hour. Using a higher curing temperature increases the amount of polyimide cross linking which in turn allows less expansion of the SVO or CSVO and, consequently, less delamination from the current collector substrate.

Suitable current collector are selected from the group consisting of stainless steel, titanium, tantalum, platinum, gold, aluminum, cobalt nickel alloys, highly alloyed ferritic stainless steel containing molybdenum and chromium, and nickel-, chromium-, and molybdenum-containing alloys.

Thus, an important aspect of the invention is that for a lithium/metal vanadium oxide-containing cell, the cathode active material is present in the cathode at a basis weight of about 0.023 grams/cm² to about 0.075 grams/cm². A more preferred basis weight is about 0.035 grams/cm² to about 0.065 grams/cm², with a most preferred basis weight being about 0.045 grams/cm² to about 0.055 grams/cm².

Cathodes may also be prepared by rolling, spreading or pressing the cathode active material, conductive diluent and binder mixture onto one of the current collectors.

A separator is provided to physically segregate the anode and cathode from each other. The separator is of an electrically insulative material to prevent an internal electrical short circuit between the electrodes, and the separator material also is chemically unreactive with the anode and cathode active materials and both chemically unreactive with and insoluble in the electrolyte. In addition, the separator material has a degree of porosity sufficient to allow flow therethrough of the electrolyte during the electrochemical reaction of the cell. The form of the separator typically is a sheet that is placed between the anode and cathode electrodes. Such is the case when the anode is folded in a serpentine-like structure with a plurality of cathode plates disposed intermediate the anode folds and received in a cell casing or when the electrode combination is rolled or otherwise formed into a cylindrical “jellyroll” configuration.

Suitable nonaqueous electrolytes comprise a lithium salt dissolved in a mixture of aprotic organic solvents comprising a low viscosity solvent including organic esters, ethers and dialkyl carbonates, and mixtures thereof, and a high permittivity solvent including cyclic carbonates, cyclic esters and cyclic amides, and mixtures thereof. Suitable nonaqueous solvents are substantially inert to the anode and cathode electrode materials and preferred low viscosity solvents include tetrahydrofuran (THF), methyl acetate (MA), diglyme, triglyme, tetraglyme, dimethyl carbonate (DMC), diethyl carbonate (DEC), dipropyl carbonate (DPC), methyl ethyl carbonate (MEC), methyl propyl carbonate (MPC), ethyl propyl carbonate (EPC), 1,2-dimethoxyethane (DME), and mixtures thereof. Preferred high permittivity solvents include propylene carbonate (PC), ethylene carbonate (EC), butylene carbonate (BC), acetonitrile, dimethyl sulfoxide, dimethyl formamide, dimethyl acetamide, γ-butyrolactone (GBL), γ-valerolactone, N-methyl-pyrrolidinone (NMP), and mixtures thereof.

Known lithium salts include LiPF₆, LiBF₄, LiAsF₆, LiSbF₆, LiClO₄, LiAlCl₄, LiGaCl₄, LiC(SO₂CF₃)₃, LiO₂, LiNO₃, LiO₂CCF₃, LiN(SO₂CF₃)₂, LiSCN, LiO₃SCF₂CF₃, LiC₆F₅SO₃, LiO₂CF₃, LiSO₃F, LiB(C₆H₅)₄, LiCF₃SO₃, and mixtures thereof. Suitable salt concentrations typically range between about 0.8 to 1.5 molar.

The assembly of the primary cell described herein is preferably in the form of a wound element configuration. That is, the fabricated negative electrode, positive electrode and separator are wound together in a “jellyroll” type configuration or “wound element cell stack” such that the anode is on the outside of the roll to make electrical contact with the cell case in a case-negative configuration. Using suitable top and bottom insulators, the wound cell stack is inserted into a metallic case of a suitable size dimension. The metallic case may comprise materials such as stainless steel, mild steel, nickel-plated mild steel, titanium, tantalum or aluminum, but not limited thereto, so long as the metallic material is compatible for use with the other cell components.

The cell header comprises a metallic disc-shaped body with a first hole to accommodate a glass-to-metal seal/terminal pin feedthrough and a second hole for electrolyte filling. The glass used is of a corrosion resistant type having up to about 50% by weight silicon such as CABAL 12, TA 23, FUSITE 425 or FUSITE 435. The positive terminal pin feedthrough preferably comprises titanium although molybdenum, aluminum, nickel alloy, or stainless steel are also useful. The cell header is typically of a material similar to that of the case. The positive terminal pin supported in the glass-to-metal seal is, in turn, supported by the header, which is welded to the case containing the electrode stack. The cell is thereafter filled with the electrolyte solution described hereinabove and hermetically sealed such as by close-welding a stainless steel ball over the fill hole, but not limited thereto.

The following examples describe the manner and process of an electrochemical cell according to the present invention, and they set forth the best mode contemplated by the inventors of carrying out the invention, but they are not to be construed as limiting.

### Example I

Five cathodes (Group 1) were prepared by mixing silver vanadium oxide and conductive additives to a binder slurry of polyamic acid, polyvinylidene fluoride, and NMP solvent. The resultant mixture in the form of a paste was cast onto an aluminum foil using a doctor blade at various gap settings. The cathodes were air dried, heated and compacted. The prepared cathodes were then punched into similarly sized disc shapes for testing. The cathodes had respective basis weights of: 0.008 grams/cm², 0.015 grams/cm², 0.034 grams/cm², 0.044 grams/cm² and 0.075 grams/cm².

### Example II

Two cathodes (Group 2) were prepared by mixing SVO and conductive additives using a mortar and pestle. A binder dispersion of 60% by weight PTFE/water was added to the powder components and further mixed. The cathode blank was then rolled to various thicknesses and punched into similarly sized disc shapes. At this point, the cathode discs were dried and compacted. The cathodes had respective basis weights of: 0.094 grams/cm² and 0.164 grams/cm².

### Example III

The Group 1 and 2 cathodes were tested using coin cells. The coin cells consisted of a lithium metal anode segregated from the cathode by a polyethylene separator, steel spacer, and activated with an electrolyte of 50:50, by volume, propylene carbonate and 1,2-dimethoxyethane.

The seven test coin cells were then subjected to a discharge protocol consisting of a pulse train of four 10-second pulses separated by 15 seconds of rest between pulses. A 30-minute rest period occurred between each pulse train. However, the pulsed current density varied depending on the gram amount of active material in the cathode. In particular, the Group 1 test cells were pulsed using a current density of 375 mA/gram of active cathode material while the Group 2 cells were pulsed using a current density of 3.75 mA/gram of cathode active material. For example, a cathode having 0.015 grams of cathode active material was pulsed at 5.6 mA whereas one having 0.027 grams of cathode active material was pulsed at 10.1 mA. This pulse train/rest period protocol was repeated until each test cell reached a desired end voltage.

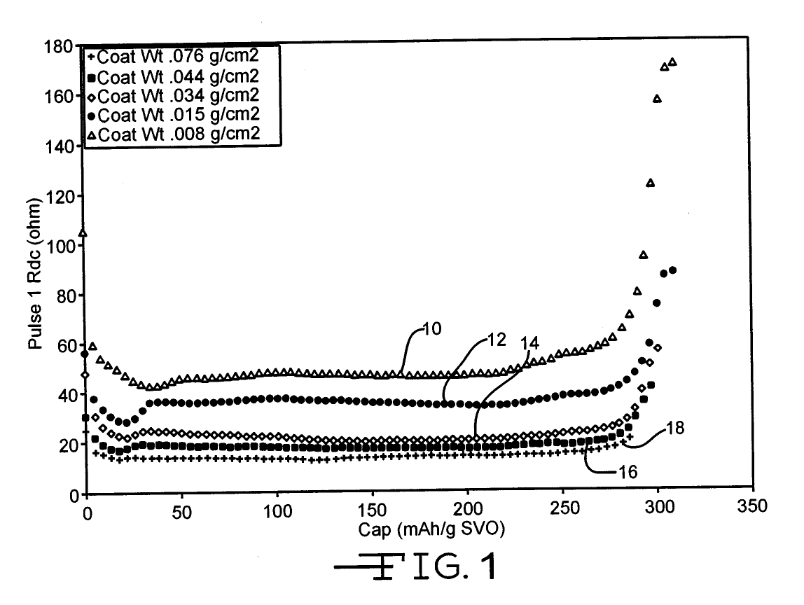

FIG. 1 was constructed from the Rdc values for pulse-1 of the repeated pulse trains for the Group 1 cells. In particular, the curve labeled 10 was constructed from the cell having a cathode basis weight of 0.008 grams/cm², curve 12 was from the cell having a cathode basis weight of 0.015 grams/cm², curve 14 was from the cell having a cathode basis weight of 0.034 grams/cm², curve 16 was from the cell having a cathode basis weight of 0.044 grams/cm² and curve 18 was from the cell having a cathode basis weight of 0.075 grams/cm². The conclusion is that the cells in Group 1 having the higher cathode basis weights resulted in lower Rdc values for each pulse train.

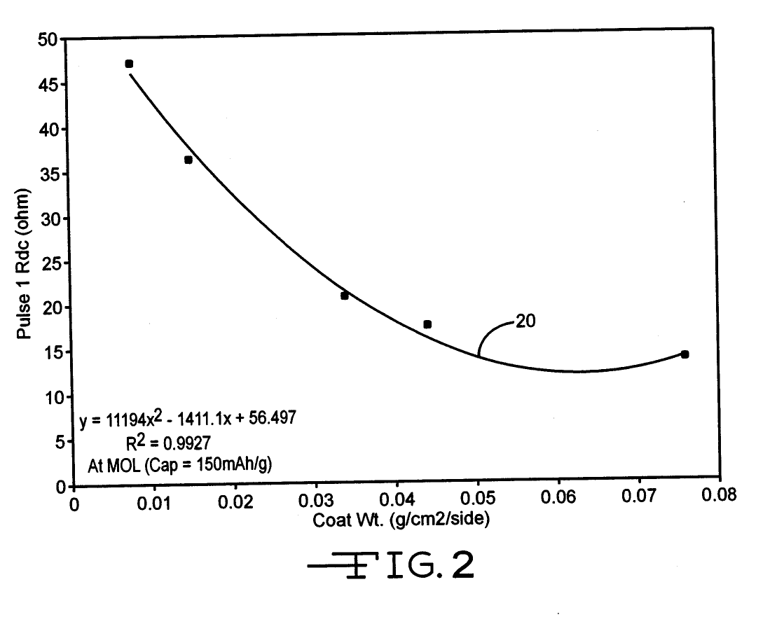

In FIG. 2, curve 20 is a plot of the pulse-1 Rdc values from each of the FIG. 1 cells at a given value of discharge capacity. In the graph, a stable portion of the curve at a discharge capacity of 150 mAh/gram was chosen as a comparison. By plotting Rdc vs. cathode basis weight, a minimum Rdc value range is evident at about 0.05 g/cm² to about 0.07 g/cm² with a second order equation defining the curve.

### Example IV

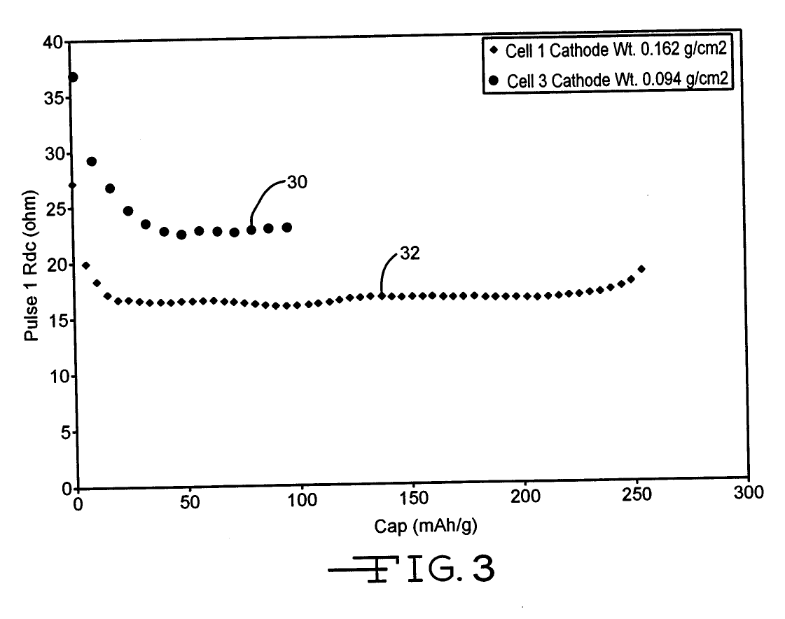

Using a pulse current standardized for cathode surface area had an even larger effect on pulse resistance. The two cathodes in Group 2 prepared according to Example II had surface areas of 1.327 grams/cm² regardless of their cathode weight. The test coin cells were pulse discharged at 50 mA/cm² (66.3 mA) using the pulse train/rest period protocol described in Example III. Rdc values for pulse-1 of each train are listed in FIG. 3. In particular, the curve labeled 30 was constructed from the cell having a cathode basis weight of 0.094 grams/cm² and curve 32 was from the cell having a cathode basis weight of 0.162 grams/cm². Cathodes of higher weights gave over three times the discharge capacity of the lighter cathodes and resulted in a lower Rdc value.

### Example V

The present invention was also shown to reduce Rdc in larger cells. Cathodes were prepared using the process described in Example I with the exception that the cathode mixture was tape cast use of a machine instead of by hand. A roll of aluminum foil was coated using a doctor blade and dried prior to re-rolling into a jellyroll configuration with a lithium anode and a segregating polyethylene separator. The cathodes were then trimmed, heated, and compacted.

One-hundred sixty cells were constructed by rolling a thusly-prepared tape cast cathode, a lithium metal anode and a polyethylene separator into a jellyroll configuration. The electrode assembly was housed in a cylindrical casing and activated with an organic electrolyte hermetically sealed therein. These cells were divided into eleven groups differentiated from each other by their cathode basis weights. The cells were pulse discharged as described above in Example III using one pulse train only. However, various current density values were used for each cell group. This was done to normalize cell Rdc by division of cathode thickness. Since each cell group had different basis weights, the cathode lengths had to be changed to allow the cell stacks to fit in the same casing volume. Therefore, the normalized Rdc value had to be multiplied by the cathode area to obtain an overall Rdc per given electrode thickness. The final normalized Rdc was calculated using the below equation:

Rdcₙₒᵣₘ=Rdc(cathode area)/cathode thickness

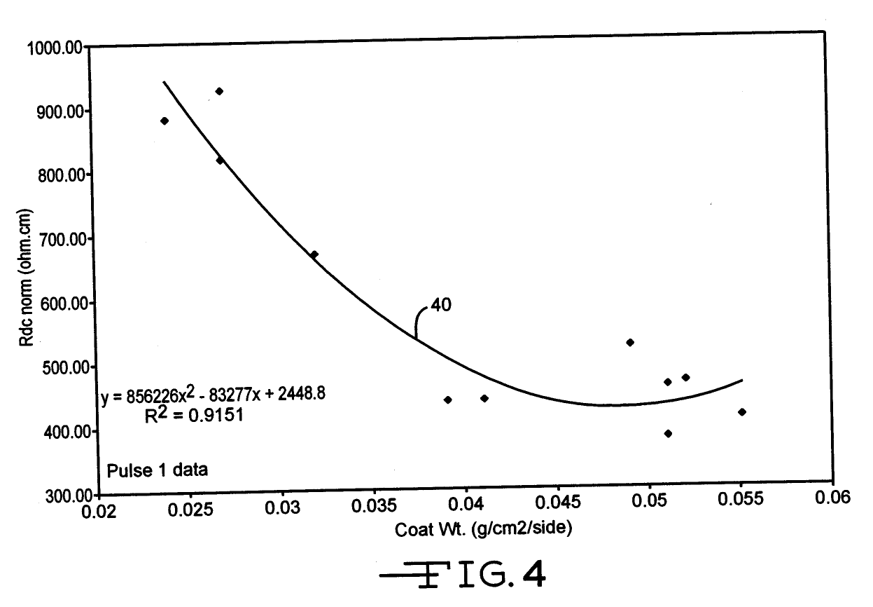

Normalized Rdc values for each cell group plotted against basis weights are plotted as curve 40 in FIG. 4. Here, it is apparent that cathode resistance during pulse-1 can be lowered by increasing the cathode weights. As with FIG. 2, fitting the greater number of pulse-1 data points on FIG. 4 results in a second order equation with a minimum value range at from about 0.045 g/cm² to about 0.052 g/cm².

It is appreciated that various modifications to the present inventive concepts described herein may be apparent to those of ordinary skill in the art without departing from the spirit and scope of the present invention as defined by the herein appended claims.

1. An electrochemical cell, which comprises:
a) a negative electrode;
b) a positive electrode comprising an electrode active material selected from one of the group:
i) a first electrode active material having the general formula SMₓV₂O_{y}, wherein SM is a metal selected from Groups IB to VIIB and VIII of the Periodic Table of Elements, and wherein x is about 0.30 to 2.0 and y is about 4.5 to 6.0 in the general formula; and
ii) a second electrode active material having the general formula CuₓAg_{y}V₂Oₓ, wherein about 0.01≦×≦1.0, about 0.01≦y≦1.0 and about 5.01≦z≦6.5; and
c) an electrolyte activating the negative and the positive electrodes segregated from each other by a separator; and
d) wherein the electrode active material is present in the positive electrode at a basis weight of about 0.045 grams/cm² to about 0.052 grams/cm².

2. (canceled)

3. (canceled)

4. The electrochemical cell of claim 1 wherein the positive electrode includes a conductive diluent selected from the group consisting of acetylene black, carbon black, graphite, carbon fiber, carbon nanotubes, nickel powder, aluminum powder, titanium powder, stainless steel powder, and mixtures thereof.

5. The electrochemical cell of claim 1 wherein the positive electrode includes a polymeric binder selected from the group consisting of polyethylene, polypropylene, fluoropolymers, fluorinated elastomers, a polyamic acid precursor, and mixtures thereof.

6. The electrochemical cell of claim 1 wherein the positive electrode comprises about 80 to 95 weight percent of the electrode active material, about 1 to 10 weight percent of a conductive diluent and about 1 to 10 weight percent of a polymeric binder.

7. The electrochemical cell of claim 1 wherein the electrolyte comprises at least on organic solvent selected from the group consisting of tetrahydrofuran, methyl acetate, diglyme, triglyme, tetraglyme, dimethyl carbonate, diethyl carbonate, dipropyl carbonate, methyl ethyl carbonate, methyl propyl carbonate, ethyl propyl carbonate, 1,2-dimethoxyethane, propylene carbonate, ethylene carbonate, butylene carbonate, acetonitrile, dimethyl sulfoxide, dimethyl formamide, dimethyl acetamide, γ-butyrolactone, γ-valerolactone, N-methyl-pyrrolidinone, and mixtures thereof.

8. The electrochemical cell of claim 1 wherein the electrolyte comprises at least on salt selected from the group consisting of LiPF₆, LiBF₄, LiAsF₆, LiSbF₆, LiClO₄, LiAlCl₄, LiGaCl₄, LiC(SO₂CF₃)₃, LiO₂, LiNO₃, LiO₂CCF₃, LiN(SO₂CF₃)₂, LiSCN, LiO₃SCF₂CF₃, LiC₆F₅SO₃, LiO₂CF₃, LiSO₃F, LiB(C₆H₅)₄, LiCF₃SO₃, and mixtures thereof.

9. An electrochemical cell, which comprises:
a) a lithium anode;
b) a cathode comprising metal vanadium oxide-containing material; and
c) an electrolyte activating the anode and the cathode segregated from each other by a separator; and
d) wherein the metal vanadium oxide-containing material is present in the cathode at a basis weight of about 0.045 grams/cm² to about 0.052 grams/cm².

10. (canceled)

11. (canceled)

12. The electrochemical cell of claim 9 wherein the cathode comprises about 80 to 95 weight percent of either silver vanadium oxide or copper silver vanadium oxide, about 1 to 10 weight percent of a conductive diluent and about 1 to 10 weight percent of a polymeric binder.

13. A method for providing an electrochemical cell, comprising the steps of:
a) providing a lithium anode;
b) mixing a metal vanadium oxide-containing material with a conductive diluent and a binder to form a cathode active mixture;
c) contacting the cathode active mixture to a current collector to form a cathode, wherein the metal vanadium oxide-containing material is present in the cathode at a basis weight of about 0.045 grams/cm² to about 0.052 grams/cm²; and
d) electrically associating the anode and the cathode with each other segregated from direct contact by a separator; and
e) activating the anode and cathode by an electrolyte provided in a casing housing the anode and cathode.

14. (canceled)

15. (canceled)

16. The method of claim 13 including providing the cathode comprising about 80 to 95 weight percent of either silver vanadium oxide or copper silver vanadium oxide, about 1 to 10 weight percent of a conductive diluent and about 1 to 10 weight percent of a polymeric binder.

17. The method of claim 13 including forming the cathode by the steps of:
a) adding PVDF to a polyamic acid/solvent slurry to create a diluted binder mixture;
b) separately dry milling the metal vanadium oxide-containing material with a conductive diluent, thereby creating a homogeneous active mixture;
c) mixing the active mixture with the diluted binder slurry causing uniform coating of the metal vanadium oxide-containing material with the binder;
d) drying the coated metal vanadium oxide-containing material press contacted to a cathode current collector; and
e) curing the active mixture contacted to the current collector to crosslink the packed metal vanadium oxide-containing material together and in close contact with the cathode current collector.

18. The method of claim 17 including curing the active mixture contacted to the current collector at a temperature of about 225° C. to about 275° C. for about 30 minutes to about 2 hours.

19. The method of claim 17 including selecting the metal vanadium oxide-containing material from silver vanadium oxide and copper silver vanadium oxide.

20. The method of claim 17 including selecting cathode current collector current from the group consisting of stainless steel, titanium, tantalum, platinum, gold, aluminum, cobalt nickel alloys, highly alloyed ferritic stainless steel containing molybdenum and chromium, and nickel-, chromium-, and molybdenum-containing alloys.
